(19) United States
(12) Patent Application Publication
(10) Pub. No.: US 2026/0304221 A1
(43) Pub. Date: Oct. 1, 2026

(54) LINEAR COMPRESSION OF GRADIENTS IN FEDERATED MACHINE LEARNING MODEL TRAINING

(71) Applicant: QUALCOMM Incorporated, San Diego, CA (US)

(72) Inventors: Yuval BEN HUR, Nesher (IL); Evgeny LEVITAN, Haifa (IL); Ariel Yaakov SAGI, Haifa (IL); Amit MOSES, Givatayim (IL); Ronen SHAKED, Kfar Saba (IL); Gideon Shlomo KUTZ, Ramat Hasharon (IL)

(21) Appl. No.: 19/091,327

(22) Filed: Mar. 26, 2025

(51) Int. Cl. H04W 28/06; H04L 41/16; H04W 72/121

(52) U.S. Cl. CPC H04W 28/06; H04L 41/16; H04W 72/121

(57) ABSTRACT

Methods, systems, and devices for wireless communications are described. A network entity may transmit, to a set of multiple user equipments (UEs), an indication of a wireless communication resource to be used by the set of multiple UEs for concurrent transmission of compressed gradient data associated with a machine learning (ML) model. The network entity may receive, via the wireless communication resource, a first signal including an over-the-air (OTA) summation of the compressed gradient data. The compressed gradient data may be compressed by multiplication of gradient data by a linear compression matrix associated with a training procedure for the ML model. The network entity may transmit, to the set of multiple UEs, a second signal including the OTA summation of the compressed gradient data or indicating an update to the ML model based on the compressed gradient data.

### FIELD OF TECHNOLOGY

The following relates to wireless communications, including linear compression of gradients in federated machine learning (ML) model training.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some UEs may perform federated machine learning (ML) model training.

### SUMMARY

The systems, methods, and devices of this disclosure each have several innovative aspects, no single one of which is solely responsible for the desirable attributes disclosed herein.

A method for wireless communications by a network entity is described. The method may include transmitting, to a set of multiple user equipments (UEs), an indication of a linear compression matrix associated with a machine learning (ML) model, transmitting, to the set of multiple UEs, an indication of a wireless communication resource to be used by the set of multiple UEs for concurrent transmission of compressed gradient data that is compressed using the linear compression matrix, receiving, via the wireless communication resource, a first signal including an over-the-air (OTA) summation of the compressed gradient data, and transmitting, to the set of multiple UEs, a second signal including the OTA summation of the compressed gradient data or indicating an update to the ML model based on the compressed gradient data.

A network entity for wireless communications is described. The network entity may include one or more memories storing processor executable code, and one or more processors coupled with the one or more memories. The one or more processors may individually or collectively be operable to execute the code to cause the network entity to transmit, to a set of multiple UEs, an indication of a linear compression matrix associated with a ML model, transmit, to the set of multiple UEs, an indication of a wireless communication resource to be used by the set of multiple UEs for concurrent transmission of compressed gradient data that is compressed using the linear compression matrix, receive, via the wireless communication resource, a first signal including an OTA summation of the compressed gradient data, and transmit, to the set of multiple UEs, a second signal including the OTA summation of the compressed gradient data or indicating an update to the ML model based on the compressed gradient data.

Another network entity for wireless communications is described. The network entity may include means for transmitting, to a set of multiple UEs, an indication of a linear compression matrix associated with a ML model, means for transmitting, to the set of multiple UEs, an indication of a wireless communication resource to be used by the set of multiple UEs for concurrent transmission of compressed gradient data that is compressed using the linear compression matrix, means for receiving, via the wireless communication resource, a first signal including an OTA summation of the compressed gradient data, and means for transmitting, to the set of multiple UEs, a second signal including the OTA summation of the compressed gradient data or indicating an update to the ML model based on the compressed gradient data.

A non-transitory computer-readable medium storing code for wireless communications is described. The code may include instructions executable by one or more processors to transmit, to a set of multiple UEs, an indication of a linear compression matrix associated with a ML model, transmit, to the set of multiple UEs, an indication of a wireless communication resource to be used by the set of multiple UEs for concurrent transmission of compressed gradient data that is compressed using the linear compression matrix, receive, via the wireless communication resource, a first signal including an OTA summation of the compressed gradient data, and transmit, to the set of multiple UEs, a second signal including the OTA summation of the compressed gradient data or indicating an update to the ML model based on the compressed gradient data.

In some examples of the method, network entities, and non-transitory computer-readable medium described herein, the compressed gradient data may be compressed by multiplication of gradient data by the linear compression matrix associated with a training procedure for the ML model.

Some examples of the method, network entities, and non-transitory computer-readable medium described herein may further include operations, features, means, or instructions for transmitting the indication of the linear compression matrix via a control channel designated for transmission of the indication of the linear compression matrix.

Some examples of the method, network entities, and non-transitory computer-readable medium described herein may further include operations, features, means, or instructions for receiving information associated with a training procedure from one or more UEs of the set of multiple UEs, where transmitting the indication includes broadcasting the indication of the linear compression matrix, and where the linear compression matrix may be based on the information.

In some examples of the method, network entities, and non-transitory computer-readable medium described herein, the information includes a set of multiple estimated covariance matrices and the method, apparatuses, and non-transitory computer-readable medium may include further operations, features, means, or instructions for estimating, based on the set of multiple estimated covariance matrices, an average covariance matrix, determining one or more basis functions in accordance with a Karhunen-Loeve decomposition, and transmitting the one or more basis functions to the set of multiple UEs.

Some examples of the method, network entities, and non-transitory computer-readable medium described herein may further include operations, features, means, or instructions for determining the linear compression matrix based on training data of the ML model.

In some examples of the method, network entities, and non-transitory computer-readable medium described herein, determining the linear compression matrix may include operations, features, means, or instructions for generating a set of gradients based on a set of training data and on the ML model, estimating, based on the set of gradients, an average covariance matrix, and determining, based on the average covariance matrix and using a Karhunen-Loeve decomposition, the linear compression matrix.

In some examples of the method, network entities, and non-transitory computer-readable medium described herein, the linear compression matrix may be stored at a memory of the network entity.

In some examples of the method, network entities, and non-transitory computer-readable medium described herein, the linear compression matrix may be associated with a training procedure for the ML model, and the training procedure includes federated ML model training.

A method for wireless communications by a UE is described. The method may include receiving an indication of a linear compression matrix associated with a ML model and associated with a set of multiple UEs including the UE, receiving an indication of a wireless communication resource to be used by the set of multiple UEs for concurrent transmission of compressed gradient data that is compressed using the linear compression matrix, transmitting a first signal including first compressed gradient data that is compressed using the linear compression matrix, and receiving, based on the first signal, a second signal including an OTA summation of compressed gradient data or indicating an update to the ML model based on the OTA summation of the compressed gradient data.

A UE for wireless communications is described. The UE may include one or more memories storing processor executable code, and one or more processors coupled with the one or more memories. The one or more processors may individually or collectively be operable to execute the code to cause the UE to receive an indication of a linear compression matrix associated with a ML model and associated with a set of multiple UEs including the UE, receive an indication of a wireless communication resource to be used by the set of multiple UEs for concurrent transmission of compressed gradient data that is compressed using the linear compression matrix, transmit a first signal including first compressed gradient data that is compressed using the linear compression matrix, and receive, based on the first signal, a second signal including an OTA summation of compressed gradient data or indicating an update to the ML model based on the OTA summation of the compressed gradient data.

Another UE for wireless communications is described. The UE may include means for receiving an indication of a linear compression matrix associated with a ML model and associated with a set of multiple UEs including the UE, means for receiving an indication of a wireless communication resource to be used by the set of multiple UEs for concurrent transmission of compressed gradient data that is compressed using the linear compression matrix, means for transmitting a first signal including first compressed gradient data that is compressed using the linear compression matrix, and means for receiving, based on the first signal, a second signal including an OTA summation of compressed gradient data or indicating an update to the ML model based on the OTA summation of the compressed gradient data.

A non-transitory computer-readable medium storing code for wireless communications is described. The code may include instructions executable by one or more processors to receive an indication of a linear compression matrix associated with a ML model and associated with a set of multiple UEs including the UE, receive an indication of a wireless communication resource to be used by the set of multiple UEs for concurrent transmission of compressed gradient data that is compressed using the linear compression matrix, transmit a first signal including first compressed gradient data that is compressed using the linear compression matrix, and receive, based on the first signal, a second signal including an OTA summation of compressed gradient data or indicating an update to the ML model based on the OTA summation of the compressed gradient data.

In some examples of the method, UEs, and non-transitory computer-readable medium described herein, the compressed gradient data may be compressed by multiplication of gradient data by the linear compression matrix associated with a training procedure for the ML model.

Some examples of the method, UEs, and non-transitory computer-readable medium described herein may further include operations, features, means, or instructions for receiving the indication of the linear compression matrix via a control channel designated for transmission of the indication of the linear compression matrix.

Some examples of the method, UEs, and non-transitory computer-readable medium described herein may further include operations, features, means, or instructions for transmitting information associated with a training procedure, where receiving the indication includes receiving the indication of the linear compression matrix via a broadcast message, and where the linear compression matrix may be based on the information.

In some examples of the method, UEs, and non-transitory computer-readable medium described herein, the information includes a set of multiple estimated covariance matrices and the method, apparatuses, and non-transitory computer-readable medium may include further operations, features, means, or instructions for receiving one or more basis functions, where the one or more basis functions may be based on an average covariance matrix associated with the set of multiple estimated covariance matrices and may be in accordance with a Karhunen-Loeve decomposition.

In some examples of the method, UEs, and non-transitory computer-readable medium described herein, the linear compression matrix may be based on training data of the ML model.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support linear compression of gradients in federated machine learning (ML) model training in accordance with one or more aspects of the present disclosure.

FIG. 3 shows an example of a process flow that supports linear compression of gradients in federated ML model training in accordance with one or more aspects of the present disclosure.

FIGS. 4 and 5 show block diagrams of devices that support linear compression of gradients in federated ML model training in accordance with one or more aspects of the present disclosure.

FIG. 6 shows a block diagram of a communications manager that supports linear compression of gradients in federated ML model training in accordance with one or more aspects of the present disclosure.

FIG. 7 shows a diagram of a system including a device that supports linear compression of gradients in federated ML model training in accordance with one or more aspects of the present disclosure.

FIGS. 8 and 9 show block diagrams of devices that support linear compression of gradients in federated ML model training in accordance with one or more aspects of the present disclosure.

FIG. 10 shows a block diagram of a communications manager that supports linear compression of gradients in federated ML model training in accordance with one or more aspects of the present disclosure.

FIG. 11 shows a diagram of a system including a device that supports linear compression of gradients in federated ML model training in accordance with one or more aspects of the present disclosure.

FIGS. 12 through 13 show flowcharts illustrating methods that support linear compression of gradients in federated ML model training in accordance with one or more aspects of the present disclosure.

### DETAILED DESCRIPTION

Some wireless communications systems may implement federated machine learning (ML) model training. For example, multiple wireless communications devices, such as user equipments (UEs), network entities, or both, may use respective local data to update the ML model and share the updated ML model with other wireless communications devices that are part of the federated ML model training. Additionally, or alternatively, wireless communications systems may implement learned model transfer. For example, a wireless communications device, such as a network entity, may deliver a full ML model, a portion of the ML model, or an update to the ML model via an over-the-air (OTA) interface. In some cases, wireless communications devices may perform a combination of the federated ML model training and learned model transfer. For example, wireless communications devices may implement federated ML model training using OTA summation to communicate ML models that are updated in accordance with the federated ML model training.

In such cases, individual UEs in a wireless communications system may calculate gradients using their own local data. For example, a first UE may calculate one or more first gradients using data at the first UE, a second UE may calculate one or more second gradients using data at the second UE, and so on. Each of the individual UEs may, at a same time and using a same frequency channel (e.g., concurrently, simultaneously, on a same communication resource), transmit modulated gradients to a network entity. The network entity may receive the modulated gradients from the individual UEs as an OTA summation. For example, as physical signals that include the modulated gradients travel OTA, the physical signals may combine to form a summed signal (i.e., an OTA summation). Put another way, the UEs may transmit physical signals including modulated gradients individually, and the network entity may receive a combination of the physical signals as an OTA summation. The network entity may return (e.g., transmit) the OTA summation to the UEs, and the UEs may update their individual ML models (e.g., a federated ML model). In some cases, the UEs may compress the gradients to reduce use of communication resources. However, because the network entity receives the modulated gradients as an OTA summation, the UEs must compress the gradients while preserving (e.g., without distorting) the OTA summation, such as in a linear manner.

As described herein, wireless communications devices involved in federated ML model training may support linear compression of gradients, thereby reducing use of communication resources while preserving an OTA summation. For example, wireless communications devices, such as UEs, may use a linear compression matrix to compress gradients, where the linear compression matrix allows a network entity receiving the compressed gradients to receive the compressed gradients as the OTA summation. The UEs may compress the gradients according to a compression matrix determined by the UEs or signaled by a network entity. For example, the compression matrix may be predefined (e.g., stored in memory of the UEs or the network entity), estimated based on online data during ML model training, indicated to the UEs via signaling, or the like. As an example, the network entity may signal (e.g., indicate, notify) the UEs of which linear compression matrix to use for compressing gradients (e.g., indicated from a group of compression matrices available for compressing gradients). In some cases, the network entity may calculate the linear compression matrix and may transmit signaling indicating the linear compression matrix to the UEs. The UEs may apply the linear compression matrix to compress calculated gradients and may transmit the compressed gradients to the network entity. The network entity may receive the gradients as an OTA summation and transmit the OTA summation or an ML model updated based on the gradients within the OTA summation back to the UEs.

By using the linear compression matrix, the UEs may reduce data volumes (e.g., reduce a volume of the gradient data). Reduction to the data volumes may be associated with improved bandwidth efficiency. Specifically, when the UEs transmit the compressed gradients to the network entity, the UEs may communicate the same information (e.g., gradient data) over a smaller bandwidth because the information is compressed. Additionally, because the compression matrix is linear, the UEs may preserve the OTA summation. Accordingly, using the linear compression matrix may allow the wireless communications devices described herein to reduce data volumes and improve bandwidth efficiency while maintaining the OTA summation, which allows the devices to extract the average gradient data from the combined physical signals and use the extracted average gradient data for federated ML model training. Further, by selecting and indicating a linear compression matrix (e.g., by a network entity), distortion associated with the OTA sum may be prevented or otherwise reduced.

Aspects of the disclosure are initially described in the context of wireless communications systems. Aspects of the disclosure are also described in the context of a process flow. Aspects of the disclosure are further illustrated by and described with reference to apparatus diagrams, system diagrams, and flowcharts that relate to linear compression of gradients in federated ML model training.

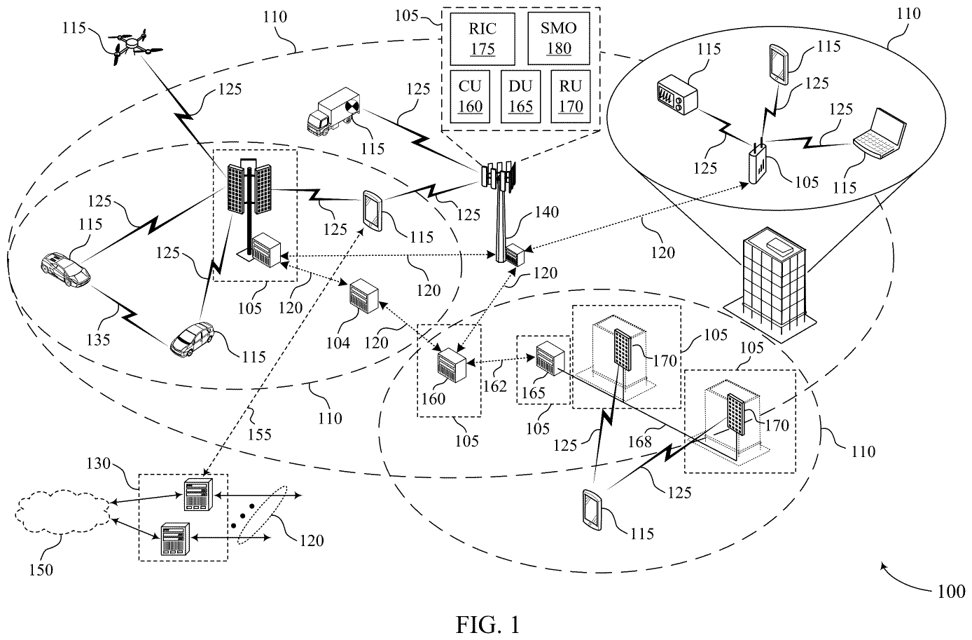

FIG. 1 shows an example of a wireless communications system 100 that supports linear compression of gradients in federated ML model training in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support linear compression of gradients in federated ML model training as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support federated ML model training and OTA summation via linear compression matrices. For example, multiple decentralized edge nodes (e.g., UEs 115, network entities 105, or other wireless communications devices described herein) may be involved in the federated ML model training. Each node may use local data samples to update the ML model and may share the update with the other nodes (e.g., among the network). Additionally, or alternatively, the nodes may support learned model transfer. For example, the nodes may support delivery of a full ML model, a part of the ML model, or an update to the ML model (e.g., when the ML model is known at the receiver) via an air interface. As described herein, wireless communications devices may use PHY layer processing to enable efficient federated training and learned model transfer.

The UEs 115 may apply a linear compression matrix to compress an update to the ML model, such as gradient data (also referred to herein as “gradients” and “gradient vectors”). Because gradients may be correlated among the UEs 115 (e.g., across a neural network supporting the federated ML model), the compression may reduce use of communication resources. For example, UEs 115 may reduce a size of the gradient data transmitted to the network entity 105 by compressing the gradient data. The UEs 115 may transmit the compressed gradient data via physical signals that, as the physical signals propagate through the air, combine to form an OTA summation. A network entity 105 may receive an OTA summation including the compressed gradient data of each of the UEs 115. For example, the network entity 105 may receive a combination of the physical signals, where the network entity 105 may extract the average gradients from the combined physical signals (i.e., the OTA summation). That is, the linear compression matrix used to compress the gradients may be invariant to coherent OTA summation. The network entity 105 may transmit the OTA summation back to the UEs 115. The UEs 115 may extract the average gradients from the OTA summation and use the gradients to train the federated ML model.

Techniques described herein may support reduced data volumes (e.g., in accordance with compressing gradients), which may improve bandwidth efficiency. Additionally, the techniques described herein may be implemented in hardware or software, and may be relatively simple (e.g., involve matrix-vector multiplications) compared to other compression schemes. Further, the linear compression matrix may be implemented flexibly in a wireless communications system, such as by being predefined or data-driven.

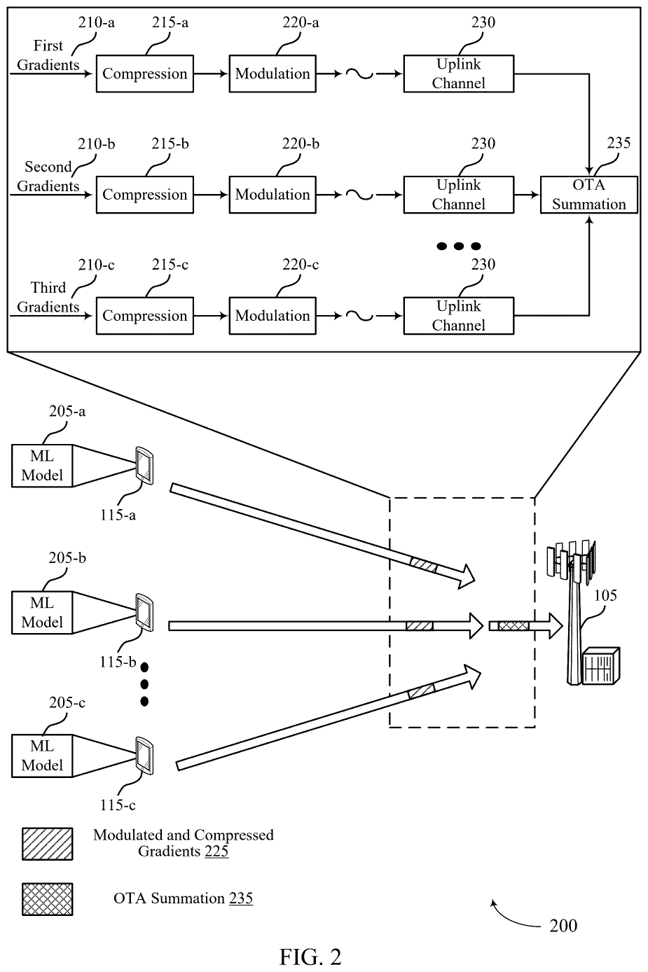

FIG. 2 shows an example of a wireless communications system 200 that supports linear compression of gradients in federated ML model training in accordance with one or more aspects of the present disclosure. The wireless communications system 200 may implement or be implemented by the wireless communications system 100. For example, the wireless communications system 200 may include a network entity 105, a UE 115-a, a UE 115-b, and a UE 115-c, which may be examples of corresponding devices as described with reference to FIG. 1.

While three UEs are illustrated and described in the example of FIG. 2, it may be understood that more or fewer than three UEs may be included in a wireless communications system 200 that supports the aspects described herein. That is, the techniques described herein related to federated ML model training and OTA summation may involve two or more UEs.

The wireless communications system 200 may support federated ML model training and OTA summation via linear compression matrices. For example, the UE 115-a, the UE 115-b, and the UE 115-c may support federated learning. That is, the UEs 115 may each maintain an ML model and, together, perform federated learning to train their respective ML models. The UE 115-a may be associated with an ML model 205-a, the UE 115-b may be associated with an ML model 205-b, and the UE 115-c may be associated with an ML model 205-c. The UE 115-a, the UE 115-b, and the UE 115-c may train the ML model 205-a, the ML model 205-b, and the ML model 205-c via federated learning. The ML model 205-a, the ML model 205-b, and the ML model 205-c may be examples of copies of a same ML model stored or used locally at the respective UEs. That is, the ML model 205-a, the ML model 205-b, and the ML model 205-c may be used to perform a same function at the respective UEs.

The UEs 115 may perform the federated ML model training by coherently transmitting modulated and compressed gradients 225 to the network entity 105 on the same communication resource. For example, the UEs 115 may calculate gradients using local data. That is, the UE 115-a may calculate first gradients 210-a based on data at the UE 115-a, the UE 115-b may calculate second gradients 210-b based on data at the UE 115-b, and the UE 115-c may calculate third gradients 210-c using data at the UE 115-c.

For example, the ML model 205-a, the ML model 205-b, and the ML model 205-c may be examples of image processing models. The UE 115-a may use images stored at the UE 115-a, the UE 115-b may use images stored at the UE 115-b, and the UE 115-c may use images stored at the UE 115-c to train the ML model 205-a, the ML model 205-b, and the ML model 205-c, respectively. Based on the training using locally stored images, the UEs 115 may determine gradients of the respective ML models. The UEs 115 may share such gradients among each other using the federated ML model training described herein (e.g., by transmitting the gradients to the network entity 105 and receiving the sum of the gradients or ML model updates in response) such that each UE may improve their respective ML model without sharing the actual training data (e.g., the images).

As used herein, “gradients” or “gradient data” may refer to a measurement of a change in weights of an ML model with regard to a change in error. In some aspects, a gradient may be understood as a slope of a function descriptive of a rate of ML model learning. For example, a higher gradient may correspond to a steeper slope in which the ML model is learning relatively quickly. Alternatively, a low (or zero) gradient may indicate that the ML model learning has slowed (or stopped altogether). In some cases, the UEs 115 may use the gradients to determine whether convergence is achieved. For example, an ML model may reach convergence when a cost function reaches a threshold (e.g., minimum) level of error. The UEs 115 may use the gradients to perform gradient descent and locate the threshold level of error and, accordingly, reach convergence.

The UEs 115 may compress the gradients to reduce signaling and resource overhead. The UEs 115 may compress the gradients by applying a linear compression matrix (i.e., such that an OTA summation is maintained, or, in other words, the OTA summation of compressed gradients equals the result of compressing the OTA summation of the gradients). For example, the UE 115-a may apply a compression 215-a to the first gradients 210-a, the UE 115-b may apply a compression 215-b to the second gradients 210-b, and the UE 115-c may apply a compression 215-c to the third gradients 210-c.

In some examples, the linear compression matrix (e.g., V) may be predefined. That is, the linear compression matrix may be stored in respective memories of the UEs 115 (e.g., a memory of the UE 115-a, a memory of the UE 115-b, and a memory of the UE 115-c) and a memory of the network entity 105. In such examples, the linear compression matrix may be an example of a subset of rows or columns from the discrete cosine transform (DCT) matrix (or some other linear transformation). For example, a DCT may express a finite sequence of data points in terms of a sum of cosine functions oscillating at different frequencies.

In some other examples, the linear compression matrix may be data-driven. For example, uniform linear projection of gradients may be performed across a set of wireless communications devices (e.g., nodes). In an example, a wireless communications device (e.g., the UE 115-a, the UE 115-b, the UE 115-c, or the network entity 105) may estimate the linear compression matrix based on online data during training. For example, the network entity 105 may train an n×k compression matrix V=[v₁, . . . , v_{K}] (where each of the vₖ entries in the matrix are orthonormal and assuming left-multiplication by V^{T}) and share the compression matrix V with the UEs 115.

As an example, the network entity 105 may estimate an average covariance matrix of an OFDM symbol or several OFDM symbols across a subset of the online data (e.g., a mini-batch). The network entity 105 may use a Karhunen-Loeve decomposition (or another linear decomposition) to set the columns or rows of the linear compression matrix to k eigenvectors having strongest eigenvalues. Put another way, the network entity 105 may generate a gradient vector gₘ from training data (e.g., obtained from the UEs 115), estimate a covariance matrix of the gradient vector gₘ, and use the Karhunen-Loeve decomposition (e.g., an SVD decomposition, a mathematical projection) to obtain an n×n matrix. The network entity 105 may select, from the n×n matrix, k rows (e.g., eigenvectors) that satisfy a threshold quantity of rows (e.g., where n is 2k, 4k, etc.).

The linear compression matrix may be static or adaptive. In examples in which the linear compression matrix is static, the network entity 105 may notify the UEs 115 of the linear compression matrix (e.g., the linear compression matrix chosen by the network entity 105) via a designated control channel. Alternatively, in examples in which the linear compression matrix is adaptive (e.g., may be changed throughout the federated ML model training), the UEs 115 may transmit information (e.g., relevant information) to the network entity 105. For example, the UE 115 may transmit information associated with the ML model, such as locally estimated parameters, including covariance matrices of gradient vectors. The network entity 105 may use the information from the UEs 115 to calculate the linear compression matrix and may transmit (e.g., broadcast) the calculated linear compression matrix or an indication of the linear compression matrix selection to the UEs 115. As such, the UEs 115 may employ the same compression scheme in order to preserve coherent OTA summation.

As an example, each of the UEs 115 may transmit, to the network entity 105, locally estimated covariance matrices of gradient vectors. The network entity 105 may average the locally estimated covariance matrices associated with the respective UEs across the UEs and mini-batches. For example, the network entity 105 may obtain an average covariance matrix. The network entity 105 may use the obtained covariance matrix to determine (e.g., conclude) basis functions for a Karhunen-Loeve decomposition. The network entity 105 may transmit (e.g., broadcast) the basis functions to the UEs 115.

To compress the gradients, the UEs 115 may each project an n×1 vector of gradients gₘ. For example, the UE 115-a may project the n×1 vector of the first gradients 210-a (e.g., g₁). The UE 115-a may multiply the vector of the first gradients g₁ by a transpose of the compression matrix V^{T} (e.g., a transposed version of the compression matrix V, such as switching the rows with the columns) in accordance with left-multiplication as shown in Equation 1 below. The linear compression matrix V may have fewer columns than rows (e.g., n>k) such that λₘ is shorter than (e.g., a compressed version of) gₘ. In some other examples, the linear compression matrix may be applied as a right-multiplication (e.g., as V).

$${λ}_{m} = {V}^{T} {g}_{m} \qquad ( 1 )$$

After compressing the gradients, the UEs 115 may modulate the compressed gradients. For example, the UE 115-a may apply a modulation 220-a to the first compressed gradients (e.g., λ₁), the UE 115-b may apply a modulation 220-b to the second compressed gradients (e.g., λ₂), and the UE 115-c may apply a modulation 220-c to the third compressed gradients (e.g., λ₃). Put another way, the UEs 115 may convert the compressed gradient data into respective physical waveforms.

After modulating the compressed gradients, the UEs 115 may transmit the modulated and compressed gradients 225 to the network entity 105 via a same uplink channel. For example, the UE 115-a may transmit the modulated, compressed first gradients to the network entity 105 via an uplink channel 230, the UE 115-b may transmit the modulated, compressed second gradients to the network entity 105 via the uplink channel 230, and the UE 115-c may transmit the modulated, compressed third gradients to the network entity 105 via the uplink channel 230. Put another way, the UEs 115 may transmit the modulated and compressed gradients 225 as physical waveforms via uplink channels to the network entity 105. The UEs 115 may transmit the modulated and compressed gradients 225 at a same time (e.g., simultaneously, concurrently, etc.). For example, the UEs 115 may transmit waveforms (e.g., the modulated, compressed gradients) at a same time and via a same channel (e.g., via same resource elements) such that the network entity 105 receives the OTA summation 235.

The network entity 105 may receive the modulated and compressed gradients 225 as an OTA summation 235. For example, the physical waveforms carrying the modulated and compressed gradients 225 may combine as the physical waveforms propagate OTA from the respective UEs to the network entity 105. The combination of the physical waveforms may form the OTA summation 235 (e.g., Σₘλₘ, where m=[1, 2, 3] in the example of FIG. 2). In the OTA summation 235, the sum (or the average) of the uncompressed gradients may be extracted or approximated. That is, by applying the linear compression matrix to compress the gradients, the OTA summation 235 may be represented according to Equation 2 below.

$$f ( {g}_{1} ) + … f ( {g}_{M} ) \approx f ( {g}_{1} + … + {g}_{M} ) \qquad ( 2 )$$

Some compression schemes may distort the OTA summation 235. For example, in some other wireless communications systems, wireless communications devices may use non-linear mappings (e.g., non-linear compression functions), which may distort the summation when transmitted via the OTA summation 235. Put another way, non-linear compression may not preserve an OTA summation 235 in which the sum of the gradients is extractable (e.g., may not preserve linearity as represented by Equation 2).

The network entity 105 may, based on receiving the OTA summation 235, transmit the OTA summation 235 back to the UEs. Additionally, or alternatively, the network entity 105 may extract some information from the OTA summation 235 (e.g., from the gradients within the OTA summation 235), and transmit the extracted information back to the UEs 115. As an example, the network entity 105 extract the gradients from the OTA summation 235 and, based on the extracted gradients, update the ML model. In such examples, the network entity 105 may transmit the updated ML model to the UEs 115 (e.g., the entire model or the updated portion).

The UEs 115 may update the respective ML models based on the OTA summation 235 or the updated ML model. For example, the UEs 115 may extract gradients from the OTA summation 235 and use the extracted gradients to update the respective ML models. Alternatively, the UEs 115 may replace the ML models with the updated ML model indicated by the network entity 105 (or replace a portion thereof). In examples in which the UEs 115 extract the gradients, the UEs 115 may multiply the OTA summation 235 by the linear compression matrix V (e.g., for left-multiplication) to obtain the decompressed gradients. For example, the UEs 115 may obtain the decompressed sum of gradients in accordance with Equation 3 below. As shown in Equation 3, the UEs 115 may receive the OTA summation transmitted back from the network entity 105 Σₘ λₘ (e.g., in accordance with Equation 1 above). The UEs 115 may multiply the OTA summation transmitted back from the network entity 105 Σₘ λₘ by the compression matrix V. This corresponds to extracting the compressed sum of gradients based on Equation 3 below, where λₘ is substituted with V^{T} gₘ, and the term V^{T} is moved outside the summation based on the compression matrix being linear. The term VV^{T} may be an example of a unity matrix (or approximately a unity matrix) based on each of the vₖ entries in the matrix being orthonormal.

$$\hat{λ} = V \cdot ( {\sum }_{m} {λ}_{m} ) = V \cdot ( {\sum }_{m} {V}^{T} {g}_{m} ) = {VV}^{T} {\sum }_{m} {g}_{m} \qquad ( 3 )$$

The wireless communications devices in the wireless communications system 200 may repeat one or more of the operations described with reference to FIG. 2 to achieve ML model convergence. That is, the UEs 115 may, again, calculate gradients based on local data, compress and modulate the calculated gradients, transmit the compressed and modulated gradients, and receive the OTA summation or updated model until model convergence is achieved.

In some examples, the UEs 115 may indicate, to the network entity 105, use of compression. For example, the UEs 115 may indicate use of compression such that the network entity 105 may be able to decompress the gradients. Put another way, a transmitter may notify a receiver regarding the use of compression so that the receiver is able to decompress the data. The indication may be communicated via a control channel (e.g., be included in a control message or control signaling).

In some examples, wireless communications devices may implement a process to detect compression of gradients. For example, the network entity 105 may detect whether gradient data is compressed in the OTA summation 235 by transmitting a gradients vector with k<NFFT real numbers and remaining 0s. The network entity 105 may record a signal transmitted through an antenna of the network entity 105. The network entity 105 may demodulate an OFDM block and observe amplitude, phase, or both per subcarrier. The network entity 105 may compare a quantity of non-zero transmitted phases and a quantity of recorded phases. If the quantity of non-zero transmitted phases are different than the quantity of recorded phases, the network entity 105 may determine that gradient compression is used. Otherwise, the network entity 105 may determine that the gradients are uncompressed (e.g., no gradient compression).

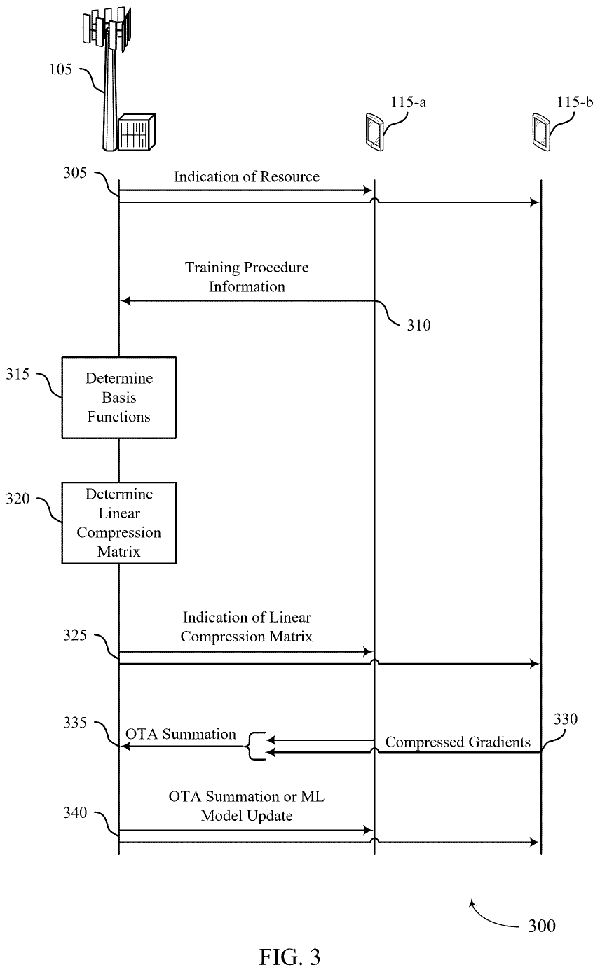

FIG. 3 shows an example of a process flow 300 that supports linear compression of gradients in federated ML model training in accordance with one or more aspects of the present disclosure. The process flow 300 may implement or be implemented by aspects of the wireless communications system 100, the wireless communications system 200, or both. For example, the process flow 300 may include a network entity 105, a UE 115-a, and a UE 115-b, which may be examples of corresponding devices as described with reference to FIGS. 1 and 2.

Alternative examples of the following may be implemented, where some operations are performed in a different order than described or are not performed at all. In some examples, operations may include additional features not mentioned below, or further operations may be added. Although the network entity 105, the UE 115-a, and the UE 115-b are shown performing the operations of the process flow 300, some aspects of some operations may also be performed by one or more other wireless devices.

At 305, the network entity 105 may transmit an indication of a resource to the UEs 115. For example, the network entity 105 may transmit, to the UE 115-a and the UE 115-b (e.g., to multiple UEs), an indication of a wireless communication resource to be used by the UE 115-a and the UE 115-b for concurrent transmission of compressed gradient data associated with a ML model.

At 310, the network entity 105 may obtain training procedure information from the UE 115-a. For example, the network entity 105 may obtain information associated with the training procedure from the UE 115-a (e.g., from one or more UEs of the multiple UEs). The information may include multiple estimated covariance matrices. The network entity 105 may determine parameters associated with the linear compression matrix at 315 based on the information associated with the training procedure. For example, at 315, the network entity 105 may determine basis functions. The network entity 105 may estimate, based on the multiple estimated covariance matrices, an average covariance matrix and determine one or more basis functions in accordance with a Karhunen-Loeve decomposition. The network entity 105 may transmit the basis functions to the UEs 115 (e.g., to multiple UEs).

At 320, the network entity 105 may determine a linear compression matrix. For example, the network entity 105 may determine the linear compression matrix based on training data of the ML model. Determining the linear compression matrix may include generating a set of gradients based on a set of training data and on the ML model. The network entity 105 may estimate, based on the set of gradients, an average covariance matrix and determine, based on the average covariance matrix and using a Karhunen-Loeve decomposition, the linear compression matrix.

At 325, the network entity 105 may transmit an indication of a linear compression matrix. For example, the network entity 105 may transmit an indication of the linear compression matrix to the UE 115-a and the UE 115-b (e.g., to multiple UEs). In some examples, the network entity 105 may transmit the indication of the linear compression matrix via a control channel designated for transmission of the indication of the linear compression matrix (e.g., indicated statically). Additionally, or alternatively, the linear compression matrix may be stored at a memory of the network entity 105 (e.g., predefined). In such examples, the UE 115-a and the UE 115-b may store the linear compression matrix at respective memories.

At 330, the UE 115-a and the UE 115-b may transmit compressed gradients to the network entity 105. For example, the UE 115-a and the UE 115-b may obtain gradient data, compress the gradient data, and modulate the compressed gradient data. The compression and modulation may be described in greater detail elsewhere herein, including with reference to FIG. 2. The UEs 115 may be part of a federated ML model training procedure. That is, the training procedure may include federated ML model training.

At 335, the network entity 105 may obtain an OTA summation. For example, the network entity 105 may receive, via the wireless communication resource (e.g., indicated at 305), a first signal including an OTA summation of the compressed gradient data, the compressed gradient data being compressed by multiplication of gradient data by the linear compression matrix associated with a training procedure for the ML model. In some examples, the network entity 105 may obtain the OTA summation at 335 based on the indication of the linear compression matrix at 325.

At 340, the network entity 105 may transmit the OTA summation or an ML model update to the UEs 115. For example, the network entity 105 may transmit, to the UE 115-a and the UE 115-b (e.g., to multiple UEs), a second signal including the OTA summation of the compressed gradient data or indicating an update to the ML model based on the compressed gradient data. The UEs 115 may update their respective ML models based on the OTA summation or the update to the ML model.

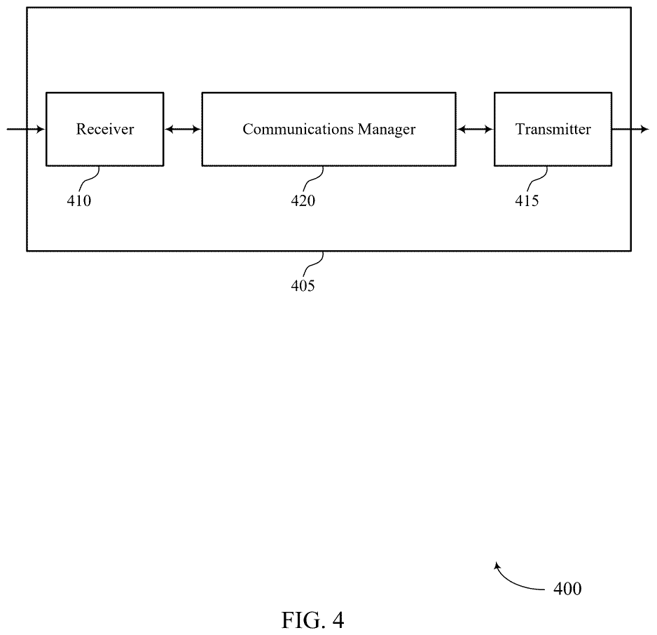

FIG. 4 shows a block diagram 400 of a device 405 that supports linear compression of gradients in federated ML model training in accordance with one or more aspects of the present disclosure. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of linear compression of gradients in federated ML model training as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting, to a set of multiple UEs, an indication of a linear compression matrix associated with a ML model. The communications manager 420 is capable of, configured to, or operable to support a means for transmitting, to the set of multiple UEs, an indication of a wireless communication resource to be used by the set of multiple UEs for concurrent transmission of compressed gradient data that is compressed using the linear compression matrix. The communications manager 420 is capable of, configured to, or operable to support a means for receiving, via the wireless communication resource, a first signal including an OTA summation of the compressed gradient data. The communications manager 420 is capable of, configured to, or operable to support a means for transmitting, to the set of multiple UEs, a second signal including the OTA summation of the compressed gradient data or indicating an update to the ML model based on the compressed gradient data.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

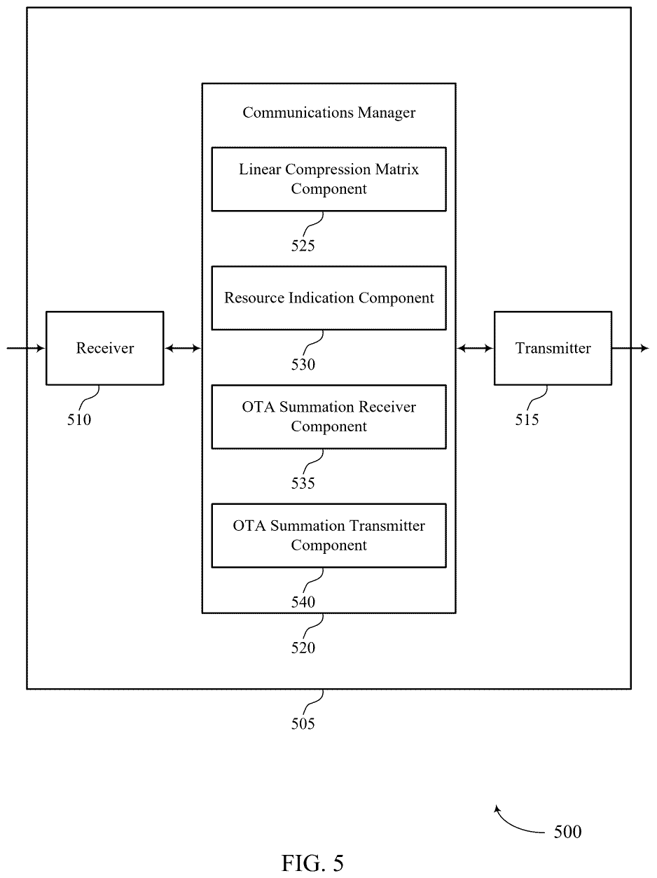

FIG. 5 shows a block diagram 500 of a device 505 that supports linear compression of gradients in federated ML model training. The device 505 may be an example of aspects of a device 405 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of linear compression of gradients in federated ML model training as described herein. For example, the communications manager 520 may include a linear compression matrix component 525, a resource indication component 530, a OTA summation receiver component 535, a OTA summation transmitter component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The linear compression matrix component 525 is capable of, configured to, or operable to support a means for transmitting, to a set of multiple UEs, an indication of a linear compression matrix associated with a ML model. The resource indication component 530 is capable of, configured to, or operable to support a means for transmitting, to the set of multiple UEs, an indication of a wireless communication resource to be used by the set of multiple UEs for concurrent transmission of compressed gradient data that is compressed using the linear compression matrix. The OTA summation receiver component 535 is capable of, configured to, or operable to support a means for receiving, via the wireless communication resource, a first signal including an OTA summation of the compressed gradient data. The OTA summation transmitter component 540 is capable of, configured to, or operable to support a means for transmitting, to the set of multiple UEs, a second signal including the OTA summation of the compressed gradient data or indicating an update to the ML model based on the compressed gradient data.

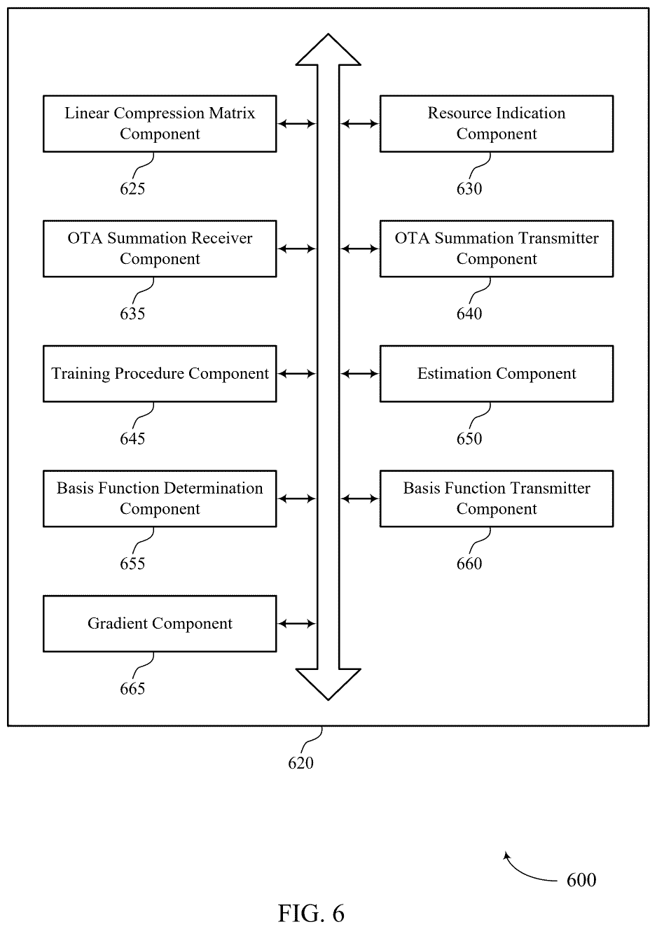

FIG. 6 shows a block diagram 600 of a communications manager 620 that supports linear compression of gradients in federated ML model training in accordance with one or more aspects of the present disclosure. The communications manager 620 may be an example of aspects of a communications manager 420, a communications manager 520, or both, as described herein. The communications manager 620, or various components thereof, may be an example of means for performing (e.g., to cause the communications manager 620 to perform) various aspects of linear compression of gradients in federated ML model training as described herein. For example, the communications manager 620 may include a linear compression matrix component 625, a resource indication component 630, a OTA summation receiver component 635, a OTA summation transmitter component 640, a training procedure component 645, an estimation component 650, a basis function determination component 655, a basis function transmitter component 660, a gradient component 665, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The linear compression matrix component 625 is capable of, configured to, or operable to support a means for transmitting, to a set of multiple UEs, an indication of a linear compression matrix associated with a ML model. The resource indication component 630 is capable of, configured to, or operable to support a means for transmitting, to the set of multiple UEs, an indication of a wireless communication resource to be used by the set of multiple UEs for concurrent transmission of compressed gradient data that is compressed using the linear compression matrix. The OTA summation receiver component 635 is capable of, configured to, or operable to support a means for receiving, via the wireless communication resource, a first signal including an OTA summation of the compressed gradient data. The OTA summation transmitter component 640 is capable of, configured to, or operable to support a means for transmitting, to the set of multiple UEs, a second signal including the OTA summation of the compressed gradient data or indicating an update to the ML model based on the compressed gradient data.

In some examples, the compressed gradient data is compressed by multiplication of gradient data by the linear compression matrix associated with a training procedure for the ML model.

In some examples, the linear compression matrix component 625 is capable of, configured to, or operable to support a means for transmitting the indication of the linear compression matrix via a control channel designated for transmission of the indication of the linear compression matrix.

In some examples, the training procedure component 645 is capable of, configured to, or operable to support a means for receiving information associated with a training procedure from one or more UEs of the set of multiple UEs, where transmitting the indication includes broadcasting the indication of the linear compression matrix, and where the linear compression matrix is based on the information.

In some examples, the information includes a set of multiple estimated covariance matrices, and the estimation component 650 is capable of, configured to, or operable to support a means for estimating, based on the set of multiple estimated covariance matrices, an average covariance matrix. In some examples, the information includes a set of multiple estimated covariance matrices, and the basis function determination component 655 is capable of, configured to, or operable to support a means for determining one or more basis functions in accordance with a Karhunen-Loeve decomposition. In some examples, the information includes a set of multiple estimated covariance matrices, and the basis function transmitter component 660 is capable of, configured to, or operable to support a means for transmitting the one or more basis functions to the set of multiple UEs.

In some examples, the linear compression matrix component 625 is capable of, configured to, or operable to support a means for determining the linear compression matrix based on training data of the ML model.

In some examples, to support determining the linear compression matrix, the gradient component 665 is capable of, configured to, or operable to support a means for generating a set of gradients based on a set of training data and on the ML model. In some examples, to support determining the linear compression matrix, the estimation component 650 is capable of, configured to, or operable to support a means for estimating, based on the set of gradients, an average covariance matrix. In some examples, to support determining the linear compression matrix, the linear compression matrix component 625 is capable of, configured to, or operable to support a means for determining, based on the average covariance matrix and using a Karhunen-Loeve decomposition, the linear compression matrix.

In some examples, the linear compression matrix is stored at a memory of the network entity.

In some examples, the linear compression matrix is associated with a training procedure for the ML model, and the training procedure includes federated ML model training.

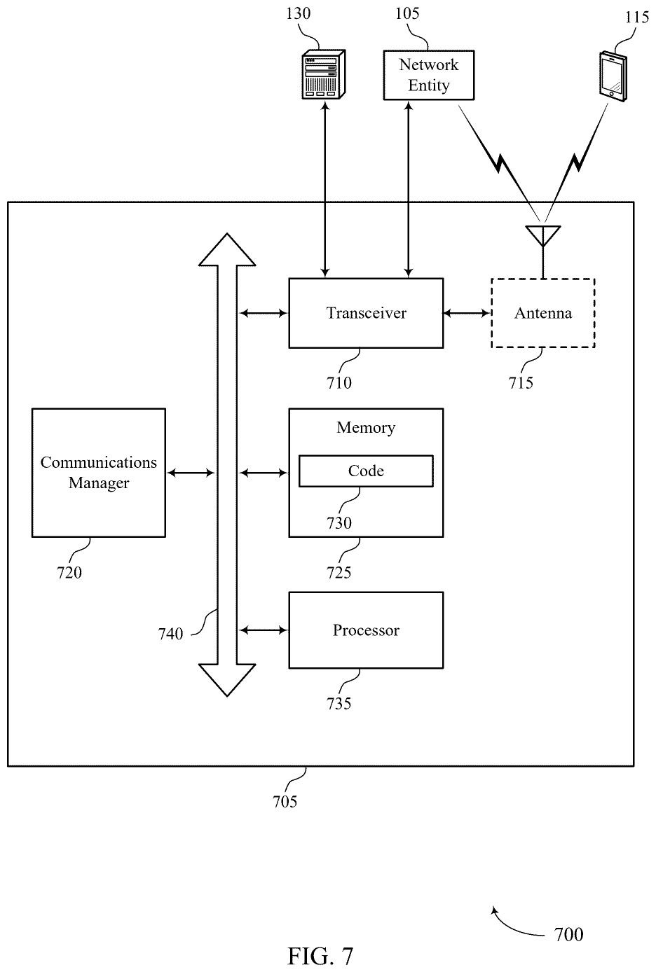

FIG. 7 shows an example of a system 700 including a device 705 that supports linear compression of gradients in federated ML model training. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. Components of the device 705 may be coupled (such as operatively, communicatively, functionally, electronically, electrically, in electronic communication) a bus 740.

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting linear compression of gradients in federated ML model training). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for transmitting, to a set of multiple UEs, an indication of a linear compression matrix associated with a ML model. The communications manager 720 is capable of, configured to, or operable to support a means for transmitting, to the set of multiple UEs, an indication of a wireless communication resource to be used by the set of multiple UEs for concurrent transmission of compressed gradient data that is compressed using the linear compression matrix. The communications manager 720 is capable of, configured to, or operable to support a means for receiving, via the wireless communication resource, a first signal including an OTA summation of the compressed gradient data. The communications manager 720 is capable of, configured to, or operable to support a means for transmitting, to the set of multiple UEs, a second signal including the OTA summation of the compressed gradient data or indicating an update to the ML model based on the compressed gradient data.

By including or configuring the communications manager 720 for operation in the device 705 as described herein, may support techniques for more efficient utilization of communication resources.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of linear compression of gradients in federated ML model training as described herein, or the at least one processor 735 and the at least one memory 725 may be otherwise configured to, individually or collectively, perform or support such operations.

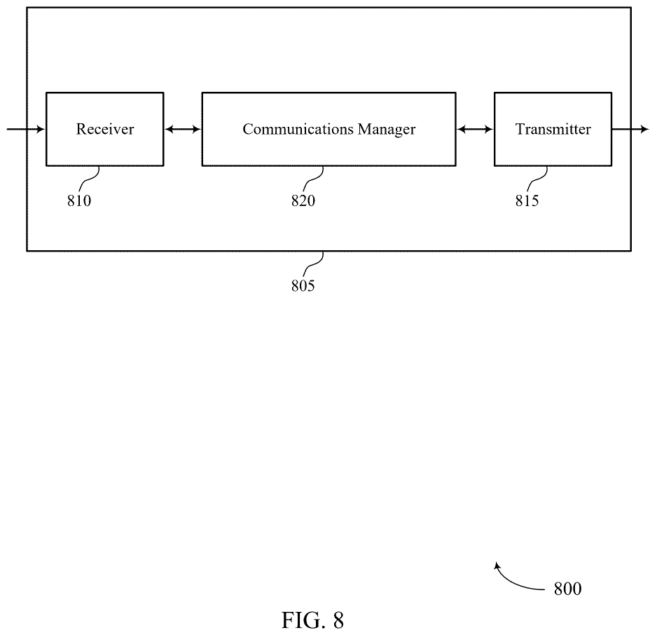

FIG. 8 shows a block diagram 800 of a device 805 that supports linear compression of gradients in federated ML model training in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to linear compression of gradients in federated ML model training). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to linear compression of gradients in federated ML model training). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of linear compression of gradients in federated ML model training as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving an indication of a linear compression matrix associated with a ML model and associated with a set of multiple UEs including the UE. The communications manager 820 is capable of, configured to, or operable to support a means for receiving an indication of a wireless communication resource to be used by the set of multiple UEs for concurrent transmission of compressed gradient data that is compressed using the linear compression matrix. The communications manager 820 is capable of, configured to, or operable to support a means for transmitting a first signal including first compressed gradient data that is compressed using the linear compression matrix. The communications manager 820 is capable of, configured to, or operable to support a means for receiving, based on the first signal, a second signal including an OTA summation of compressed gradient data or indicating an update to the ML model based on the OTA summation of the compressed gradient data.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

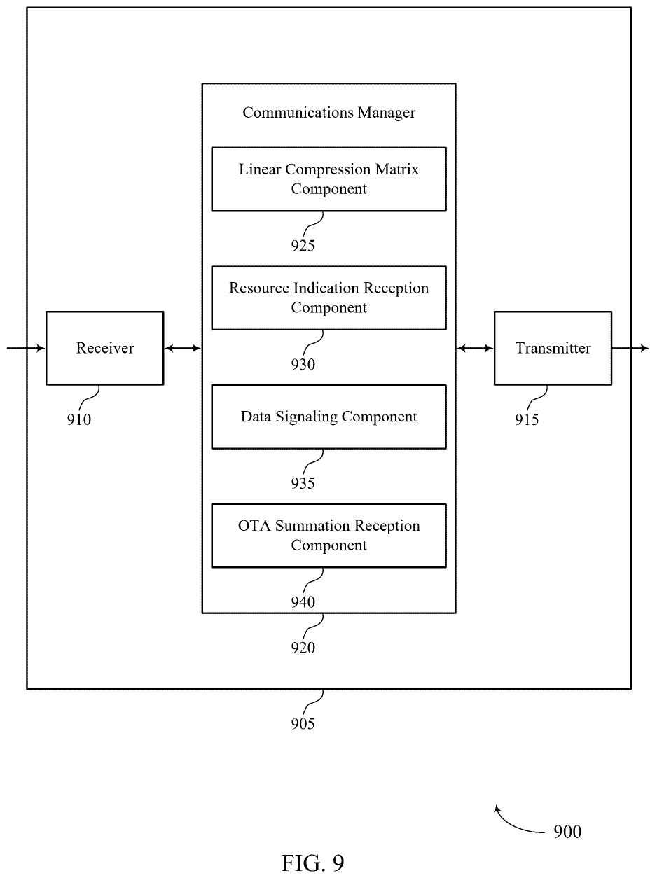

FIG. 9 shows a block diagram 900 of a device 905 that supports linear compression of gradients in federated ML model training. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to linear compression of gradients in federated ML model training). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to linear compression of gradients in federated ML model training). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of linear compression of gradients in federated ML model training as described herein. For example, the communications manager 920 may include a linear compression matrix component 925, a resource indication reception component 930, a data signaling component 935, a OTA summation reception component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The linear compression matrix component 925 is capable of, configured to, or operable to support a means for receiving an indication of a linear compression matrix associated with a ML model and associated with a set of multiple UEs including the UE. The resource indication reception component 930 is capable of, configured to, or operable to support a means for receiving an indication of a wireless communication resource to be used by the set of multiple UEs for concurrent transmission of compressed gradient data that is compressed using the linear compression matrix. The data signaling component 935 is capable of, configured to, or operable to support a means for transmitting a first signal including first compressed gradient data that is compressed using the linear compression matrix. The OTA summation reception component 940 is capable of, configured to, or operable to support a means for receiving, based on the first signal, a second signal including an OTA summation of compressed gradient data or indicating an update to the ML model based on the OTA summation of the compressed gradient data.

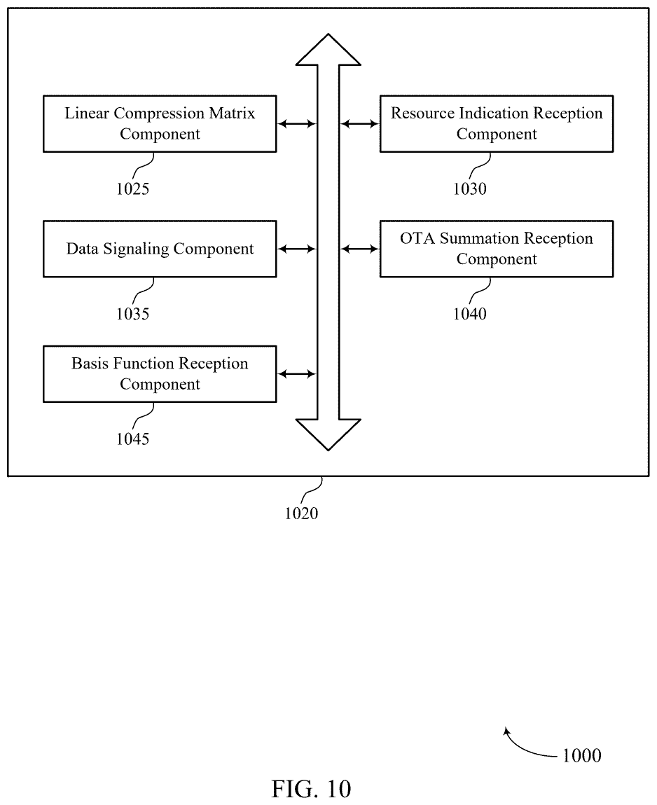

FIG. 10 shows a block diagram 1000 of a communications manager 1020 that supports linear compression of gradients in federated ML model training in accordance with one or more aspects of the present disclosure. The communications manager 1020 may be an example of aspects of a communications manager 820, a communications manager 920, or both, as described herein. The communications manager 1020, or various components thereof, may be an example of means for performing (e.g., to cause the communications manager 1020 to perform) various aspects of linear compression of gradients in federated ML model training as described herein. For example, the communications manager 1020 may include a linear compression matrix component 1025, a resource indication reception component 1030, a data signaling component 1035, a OTA summation reception component 1040, a basis function reception component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The linear compression matrix component 1025 is capable of, configured to, or operable to support a means for receiving an indication of a linear compression matrix associated with a ML model and associated with a set of multiple UEs including the UE. The resource indication reception component 1030 is capable of, configured to, or operable to support a means for receiving an indication of a wireless communication resource to be used by the set of multiple UEs for concurrent transmission of compressed gradient data that is compressed using the linear compression matrix. The data signaling component 1035 is capable of, configured to, or operable to support a means for transmitting a first signal including first compressed gradient data that is compressed using the linear compression matrix. The OTA summation reception component 1040 is capable of, configured to, or operable to support a means for receiving, based on the first signal, a second signal including an OTA summation of compressed gradient data or indicating an update to the ML model based on the OTA summation of the compressed gradient data.

In some examples, the compressed gradient data is compressed by multiplication of gradient data by the linear compression matrix associated with a training procedure for the ML model.

In some examples, the linear compression matrix component 1025 is capable of, configured to, or operable to support a means for receiving the indication of the linear compression matrix via a control channel designated for transmission of the indication of the linear compression matrix.

In some examples, the data signaling component 1035 is capable of, configured to, or operable to support a means for transmitting information associated with a training procedure, where receiving the indication includes receiving the indication of the linear compression matrix via a broadcast message, and where the linear compression matrix is based on the information.

In some examples, the information includes a set of multiple estimated covariance matrices, and the basis function reception component 1045 is capable of, configured to, or operable to support a means for receiving one or more basis functions, where the one or more basis functions are based on an average covariance matrix associated with the set of multiple estimated covariance matrices and are in accordance with a Karhunen-Loeve decomposition.

In some examples, the linear compression matrix is based on training data of the ML model.

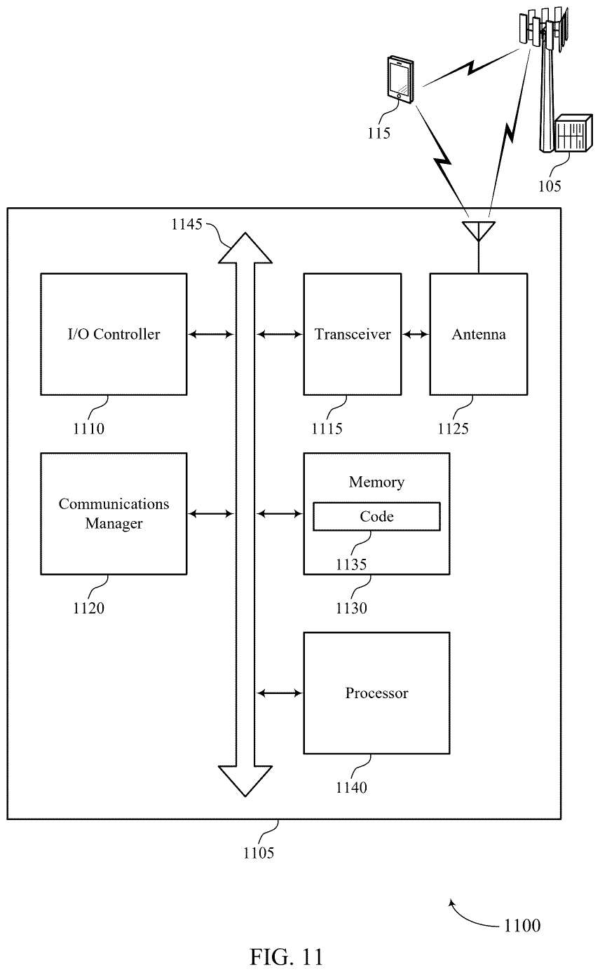

FIG. 11 shows an example of a system 1100 including a device 1105 that supports linear compression of gradients in federated ML model training. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include a communications manager 1120, an input/output (I/O) controller, such as an I/O controller 1110, a transceiver 1115, one or more antennas 1125, at least one memory 1130, code 1135, and at least one processor 1140. Components of the device 1105 may be coupled (such as operatively, communicatively, functionally, electronically, electrically, in electronic communication) a bus 1145.

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting linear compression of gradients in federated ML model training). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving an indication of a linear compression matrix associated with a ML model and associated with a set of multiple UEs including the UE. The communications manager 1120 is capable of, configured to, or operable to support a means for receiving an indication of a wireless communication resource to be used by the set of multiple UEs for concurrent transmission of compressed gradient data that is compressed using the linear compression matrix. The communications manager 1120 is capable of, configured to, or operable to support a means for transmitting a first signal including first compressed gradient data that is compressed using the linear compression matrix. The communications manager 1120 is capable of, configured to, or operable to support a means for receiving, based on the first signal, a second signal including an OTA summation of compressed gradient data or indicating an update to the ML model based on the OTA summation of the compressed gradient data.

By including or configuring the communications manager 1120 for operation in the device 1105 as described herein, may support techniques for more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of linear compression of gradients in federated ML model training as described herein, or the at least one processor 1140 and the at least one memory 1130 may be otherwise configured to, individually or collectively, perform or support such operations.

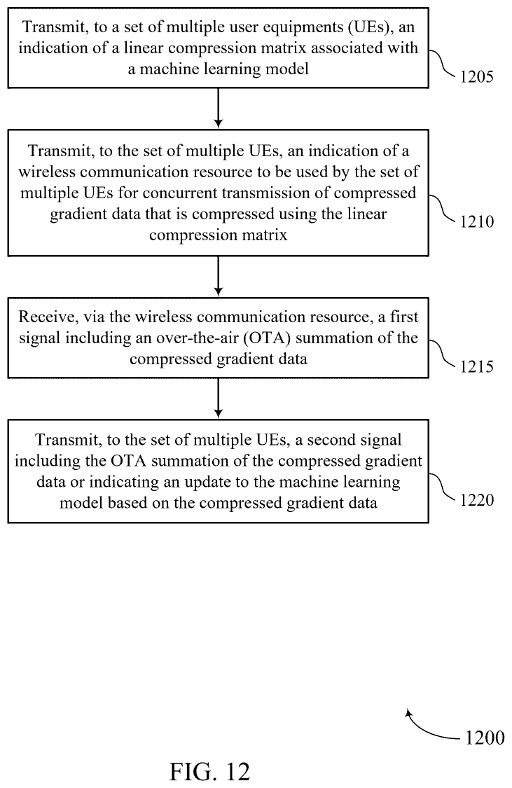

FIG. 12 shows a flowchart illustrating a method 1200 that supports linear compression of gradients in federated ML model training in accordance with one or more aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include transmitting, to a set of multiple UEs, an indication of a linear compression matrix associated with a ML model. In some examples, aspects of the operations of 1205 may be performed by a linear compression matrix component 625.

At 1210, the method may include transmitting, to the set of multiple UEs, an indication of a wireless communication resource to be used by the set of multiple UEs for concurrent transmission of compressed gradient data that is compressed using the linear compression matrix. In some examples, aspects of the operations of 1210 may be performed by a resource indication component 630.

At 1215, the method may include receiving, via the wireless communication resource, a first signal including an OTA summation of the compressed gradient data. In some examples, aspects of the operations of 1215 may be performed by a OTA summation receiver component 635.

At 1220, the method may include transmitting, to the set of multiple UEs, a second signal including the OTA summation of the compressed gradient data or indicating an update to the ML model based on the compressed gradient data. In some examples, aspects of the operations of 1220 may be performed by a OTA summation transmitter component 640.

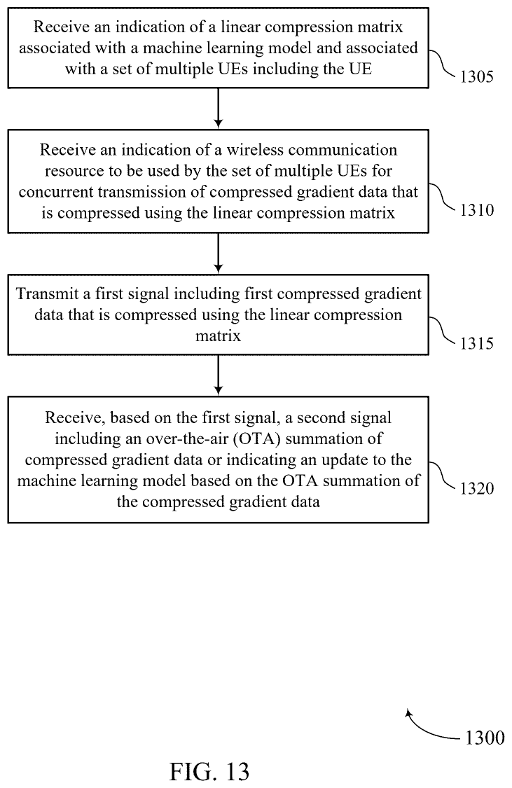

FIG. 13 shows a flowchart illustrating a method 1300 that supports linear compression of gradients in federated ML model training in accordance with one or more aspects of the present disclosure. The operations of the method 1300 may be implemented by a UE or its components as described herein. For example, the operations of the method 1300 may be performed by a UE 115 as described with reference to FIGS. 1 through 3 and 8 through 11. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a linear compression matrix associated with a ML model and associated with a set of multiple UEs including the UE. In some examples, aspects of the operations of 1305 may be performed by a linear compression matrix component 1025.

At 1310, the method may include receiving an indication of a wireless communication resource to be used by the set of multiple UEs for concurrent transmission of compressed gradient data that is compressed using the linear compression matrix. In some examples, aspects of the operations of 1310 may be performed by a resource indication reception component 1030.

At 1315, the method may include transmitting a first signal including first compressed gradient data that is compressed using the linear compression matrix. In some examples, aspects of the operations of 1315 may be performed by a data signaling component 1035.

At 1320, the method may include receiving, based on the first signal, a second signal including an OTA summation of compressed gradient data or indicating an update to the ML model based on the OTA summation of the compressed gradient data. In some examples, aspects of the operations of 1320 may be performed by a OTA summation reception component 1040.

The following provides an overview of aspects of the present disclosure:

Aspect 1: A method for wireless communications at a network entity, comprising: transmitting, to a plurality of UEs, an indication of a linear compression matrix associated with a ML model; transmitting, to the plurality of UEs, an indication of a wireless communication resource to be used by the plurality of UEs for concurrent transmission of compressed gradient data that is compressed using the linear compression matrix; receiving, via the wireless communication resource, a first signal comprising an OTA summation of the compressed gradient data; and transmitting, to the plurality of UEs, a second signal comprising the OTA summation of the compressed gradient data or indicating an update to the ML model based at least in part on the compressed gradient data.

Aspect 2: The method of aspect 1, wherein the compressed gradient data is compressed by multiplication of gradient data by the linear compression matrix associated with a training procedure for the ML model.

Aspect 3: The method of any of aspects 1 through 2, further comprising: transmitting the indication of the linear compression matrix via a control channel designated for transmission of the indication of the linear compression matrix.

Aspect 4: The method of any of aspects 1 through 3, further comprising: receiving information associated with a training procedure from one or more UEs of the plurality of UEs, wherein transmitting the indication comprises broadcasting the indication of the linear compression matrix, and wherein the linear compression matrix is based at least in part on the information.

Aspect 5: The method of any of aspects 1 through 4, wherein the information comprises a plurality of estimated covariance matrices, the method further comprising: estimating, based at least in part on the plurality of estimated covariance matrices, an average covariance matrix; determining one or more basis functions in accordance with a Karhunen-Loeve decomposition; and transmitting the one or more basis functions to the plurality of UEs.

Aspect 6: The method of any of aspects 1 through 5, further comprising: determining the linear compression matrix based at least in part on training data of the ML model.

Aspect 7: The method of aspect 6, wherein determining the linear compression matrix comprises: generating a set of gradients based at least in part on a set of training data and on the ML model; estimating, based at least in part on the set of gradients, an average covariance matrix; and determining, based at least in part on the average covariance matrix and using a Karhunen-Loeve decomposition, the linear compression matrix.

Aspect 8: The method of any of aspects 1 through 7, wherein the linear compression matrix is stored at a memory of the network entity.

Aspect 9: The method of any of aspects 1 through 8, wherein the linear compression matrix is associated with a training procedure for the ML model, and the training procedure comprises federated ML model training.

Aspect 10: A method for wireless communications at a UE, comprising: receiving an indication of a linear compression matrix associated with a ML model and associated with a plurality of UEs comprising the UE; receiving an indication of a wireless communication resource to be used by the plurality of UEs for concurrent transmission of compressed gradient data that is compressed using the linear compression matrix; transmitting a first signal comprising first compressed gradient data that is compressed using the linear compression matrix; and receiving, based at least in part on the first signal, a second signal comprising an OTA summation of compressed gradient data or indicating an update to the ML model based at least in part on the OTA summation of the compressed gradient data.

Aspect 11: The method of aspect 10, wherein the compressed gradient data is compressed by multiplication of gradient data by the linear compression matrix associated with a training procedure for the ML model.

Aspect 12: The method of any of aspects 10 through 11, further comprising: receiving the indication of the linear compression matrix via a control channel designated for transmission of the indication of the linear compression matrix.

Aspect 13: The method of any of aspects 10 through 12, further comprising: transmitting information associated with a training procedure, wherein receiving the indication comprises receiving the indication of the linear compression matrix via a broadcast message, and wherein the linear compression matrix is based at least in part on the information

Aspect 14: The method of any of aspects 10 through 13, wherein the information comprises a plurality of estimated covariance matrices, the method further comprising: receiving one or more basis functions, wherein the one or more basis functions are based at least in part on an average covariance matrix associated with the plurality of estimated covariance matrices and are in accordance with a Karhunen-Loeve decomposition

Aspect 15: The method of any of aspects 10 through 14, wherein the linear compression matrix is based at least in part on training data of the ML model.

Aspect 16: A network entity for wireless communications, comprising a processing system that includes processor circuitry and memory circuitry that stores code, the processing system configured to cause the network entity to perform a method of any of aspects 1 through 9.

Aspect 17: A network entity for wireless communications, comprising at least one means for performing a method of any of aspects 1 through 9.

Aspect 18: A non-transitory computer-readable medium storing code for wireless communications, the code comprising instructions executable by one or more processors to perform a method of any of aspects 1 through 9.

Aspect 19: A UE for wireless communications, comprising a processing system that includes processor circuitry and memory circuitry that stores code, the processing system configured to cause the UE to perform a method of any of aspects 10 through 15.

Aspect 20: A UE for wireless communications, comprising at least one means for performing a method of any of aspects 10 through 15.

Aspect 21: A non-transitory computer-readable medium storing code for wireless communications, the code comprising instructions executable by one or more processors to perform a method of any of aspects 10 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit, to a plurality of user equipments (UEs), an indication of a linear compression matrix associated with a machine learning model;
transmit, to the plurality of UEs, an indication of a wireless communication resource to be used by the plurality of UEs for concurrent transmission of compressed gradient data that is compressed using the linear compression matrix;
receive, via the wireless communication resource, a first signal comprising an over-the-air (OTA) summation of the compressed gradient data; and
transmit, to the plurality of UEs, a second signal comprising the OTA summation of the compressed gradient data or indicating an update to the machine learning model based at least in part on the compressed gradient data.

2. The network entity of claim 1, wherein the compressed gradient data is compressed by multiplication of gradient data by the linear compression matrix associated with a training procedure for the machine learning model.

3. The network entity of claim 1, wherein the one or more processors are individually or collectively further operable to execute the code to cause the network entity to:
transmit the indication of the linear compression matrix via a control channel designated for transmission of the indication of the linear compression matrix.

4. The network entity of claim 1, wherein the one or more processors are individually or collectively further operable to execute the code to cause the network entity to:
receive information associated with a training procedure from one or more UEs of the plurality of UEs, wherein transmitting the indication comprises broadcasting the indication of the linear compression matrix, and wherein the linear compression matrix is based at least in part on the information.

5. The network entity of claim 4, wherein the information comprises a plurality of estimated covariance matrices, and the one or more processors are individually or collectively further operable to execute the code to cause the network entity to:
estimate, based at least in part on the plurality of estimated covariance matrices, an average covariance matrix;
determine one or more basis functions in accordance with a Karhunen-Loeve decomposition; and
transmit the one or more basis functions to the plurality of UEs.

6. The network entity of claim 1, wherein the one or more processors are individually or collectively further operable to execute the code to cause the network entity to:
determine the linear compression matrix based at least in part on training data of the machine learning model.

7. The network entity of claim 6, wherein, to determine the linear compression matrix, the one or more processors are individually or collectively operable to execute the code to cause the network entity to:
generate a set of gradients based at least in part on a set of training data and on the machine learning model;
estimate, based at least in part on the set of gradients, an average covariance matrix; and
determine, based at least in part on the average covariance matrix and using a Karhunen-Loeve decomposition, the linear compression matrix.

8. The network entity of claim 1, wherein the linear compression matrix is stored at a memory of the network entity.

9. The network entity of claim 1, wherein:
the linear compression matrix is associated with a training procedure for the machine learning model, and
the training procedure comprises federated machine learning model training.

10. A method for wireless communications at a network entity, comprising:
transmitting, to a plurality of user equipments (UEs), an indication of a linear compression matrix associated with a machine learning model;
transmitting, to the plurality of UEs, an indication of a wireless communication resource to be used by the plurality of UEs for concurrent transmission of compressed gradient data that is compressed using the linear compression matrix;
receiving, via the wireless communication resource, a first signal comprising an over-the-air (OTA) summation of the compressed gradient data; and
transmitting, to the plurality of UEs, a second signal comprising the OTA summation of the compressed gradient data or indicating an update to the machine learning model based at least in part on the compressed gradient data.

11. The method of claim 10, wherein the compressed gradient data is compressed by multiplication of gradient data by the linear compression matrix associated with a training procedure for the machine learning model.

12. The method of claim 10, further comprising:
transmitting the indication of the linear compression matrix via a control channel designated for transmission of the indication of the linear compression matrix.

13. The method of claim 10, further comprising:
receiving information associated with a training procedure from one or more UEs of the plurality of UEs, wherein transmitting the indication comprises broadcasting the indication of the linear compression matrix, and wherein the linear compression matrix is based at least in part on the information.

14. The method of claim 13, wherein the information comprises a plurality of estimated covariance matrices, the method further comprising:
estimating, based at least in part on the plurality of estimated covariance matrices, an average covariance matrix;
determining one or more basis functions in accordance with a Karhunen-Loeve decomposition; and
transmitting the one or more basis functions to the plurality of UEs.

15. A user equipment (UE), comprising:
one or more memories storing processor-executable code; and
one or more processors coupled with the one or more memories and individually or collectively operable to execute the code to cause the UE to:
receive an indication of a linear compression matrix associated with a machine learning model and associated with a plurality of UEs comprising the UE;
receive an indication of a wireless communication resource to be used by the plurality of UEs for concurrent transmission of compressed gradient data that is compressed using the linear compression matrix;
transmit a first signal comprising first compressed gradient data that is compressed using the linear compression matrix; and
receive, based at least in part on the first signal, a second signal comprising an over-the-air (OTA) summation of compressed gradient data or indicating an update to the machine learning model based at least in part on the OTA summation of the compressed gradient data.

16. The UE of claim 15, wherein the compressed gradient data is compressed by multiplication of gradient data by the linear compression matrix associated with a training procedure for the machine learning model.

17. The UE of claim 15, wherein the one or more processors are individually or collectively further operable to execute the code to cause the UE to:
receive the indication of the linear compression matrix via a control channel designated for transmission of the indication of the linear compression matrix.

18. The UE of claim 15, wherein the one or more processors are individually or collectively further operable to execute the code to cause the UE to:
transmit information associated with a training procedure, wherein receiving the indication comprises receiving the indication of the linear compression matrix via a broadcast message, and wherein the linear compression matrix is based at least in part on the information.

19. The UE of claim 18, wherein the information comprises a plurality of estimated covariance matrices, and the one or more processors are individually or collectively further operable to execute the code to cause the UE to:
receive one or more basis functions, wherein the one or more basis functions are based at least in part on an average covariance matrix associated with the plurality of estimated covariance matrices and are in accordance with a Karhunen-Loeve decomposition.

20. The UE of claim 15, wherein the linear compression matrix is based at least in part on training data of the machine learning model.
